(19) United States
(12) Patent Application Publication
(10) Pub. No.: US 2011/0205392 A1
(43) Pub. Date: Aug. 25, 2011

(54) IMAGE CAPTURE DEVICE

(75) Inventor: Shoichi YOKOI, Osaka (JP)

(73) Assignee: PANASONIC CORPORATION, Osaka (JP)

(21) Appl. No.: 13/005,598

(22) Filed: Jan. 13, 2011

(30) Foreign Application Priority Data
Jan. 15, 2010 (JP) 2010-006603

(51) Int. Cl. H04N 9/73

(52) U.S. Cl. 348/224.1; 348/223.1; 348/E09.052

(57) ABSTRACT

The present invention provides an image capture device that can fine-tune the colors so that the image captured has appropriate colors. A digital camera 100 according to the present invention includes: a CCD image sensor 120 for capturing a subject image and generating image information; a light source estimating section 182 for calculating a white balance control value in order to adjust the white balance of the image information; a WB control section 183 for adjusting the white balance of the image information in accordance with the white balance control value; and a color tuning section 184 for changing a color corresponding to the white balance control value of the image information of which the white balance has been adjusted.

### BACKGROUND OF THE INVENTION

1. Field of the Invention

The present invention relates to an image capture device and more particularly relates to an image capture device that can adjust the white balance more finely.

2. Description of the Related Art

An image capture device such as a digital camera for capturing a moving picture or a still picture usually has a white balance adjusting function for detecting the color temperature of a light source that illuminates a subject to shoot and adjusting the white balance so that an achromatic color remains achromatic (i.e., the color white remains white). For example, Japanese Patent Application Laid-Open Publication No. 2002-095004 discloses an image capture device, which divides a given piece of image information provided by image capturing means into a number of areas, determines, by a predetermined standard, whether or not each of those areas should be selected, and sets a white balance gain based on the combination of areas selected, thereby adjusting the white balance.

### SUMMARY OF THE INVENTION

However, when shooting under two different kinds of light sources (such as a mercury lamp and a fluorescent lamp) that are set up in the same place, an image capture device with such a white balance adjusting function cannot adjust the white balance separately to those two kinds of light sources, thus generating either an unnaturally greenish or reddish image.

It is therefore an object of the present invention to provide an image capture device that can fine-tune the colors so that the image captured has appropriate colors.

To overcome the problem described above, the present invention provides an image capture device, which is characterized by including: an image capturing section for capturing a subject image and generating image information; a control value calculating section for calculating a white balance control value in order to adjust the white balance of the image information; a white balance adjusting section for adjusting the white balance of the image information in accordance with the white balance control value; and a color tuning section for changing a color corresponding to the white balance control value of the image information of which the white balance has been adjusted.

In one preferred embodiment, the control value calculating section calculates first and second white balance control values based on two pieces of information about the colors of the image information that fall within first and second color ranges, respectively, and compares the first and second white balance control values to each other, thereby determining, based on a result of the comparison, the white balance control value to adjust the white balance of the image information.

In this particular preferred embodiment, the first color range includes colors of the entire image information, and the second color range indicates a particular light source color. If the white balance of the image information has been adjusted based on the first white balance control value, the color tuning section fine-tunes a first color corresponding to the particular light source color. On the other hand, if the white balance of the image information has been adjusted based on the second white balance control value, the color tuning section fine-tunes a second color corresponding to the particular light source color.

In a specific preferred embodiment, the particular light source is a mercury-vapor lamp, and the first and second colors are green and magenta, respectively.

In another specific preferred embodiment, the particular light source is a sodium-vapor lamp, and the first and second colors are orange and blue, respectively.

In still another preferred embodiment, the first and second colors are complementary to each other.

In yet another preferred embodiment, the image capture device further includes a block memory data calculating section for dividing the image information into a number of blocks and calculating block memory data, representing average light intensities of primary colors, on a block-by-block basis. The control value calculating section calculates the first and second white balance control values based on block memory data that are associated with the first and second color ranges, respectively.

In yet another preferred embodiment, the control value calculating section calculates the difference between the first and second white balance control values, compares the difference to a predetermined threshold value, and uses, based on a result of the comparison, one of the first and second white balance control values as the white balance control value to adjust the white balance of the image information.

To overcome the problem described above, the present invention also provides an image processing method, which is characterized by including the steps of: calculating a white balance control value in order to adjust the white balance of image information that has been entered; adjusting the white balance of the image information in accordance with the white balance control value; and changing a color corresponding to the white balance control value of the image information of which the white balance has been adjusted.

According to the present invention, after the white balance of the image information that has been generated by an image capturing section has been adjusted in accordance with a white balance control value, a color corresponding to the white balance control value of that image information is changed. As a result, the colors of an image captured can be fine-tuned into appropriate ones.

### BRIEF DESCRIPTION OF THE DRAWINGS

FIG. 1 is a front view of a digital camera according to a first preferred embodiment of the present invention.

FIG. 2 is a rear view of the digital camera of the first preferred embodiment of the present invention.

FIG. 3 illustrates an electrical configuration for the digital camera of the first preferred embodiment of the present invention.

FIG. 4 outlines how a BM integrator works in the first preferred embodiment of the present invention.

FIG. 5 illustrates a detailed configuration for a WB corrector according to the first preferred embodiment of the present invention.

FIG. 6 is a flowchart showing how a color tuning operation is carried out according to the first preferred embodiment of the present invention.

FIG. 7 shows how WB control values (gains) are generated for respective BM data according to the first preferred embodiment of the present invention.

FIG. 8 shows a situation where there is a significant difference between the average of WB control values falling within a mercury-vapor lamp color range and that of WB control values over the entire image color range in the first preferred embodiment of the present invention.

FIG. 9 shows a situation where there is a little difference between the average of WB control values falling within the mercury-vapor lamp color range and that of WB control values over the entire image color range in the first preferred embodiment of the present invention.

### DETAILED DESCRIPTION OF PREFERRED EMBODIMENTS

### Embodiment 1

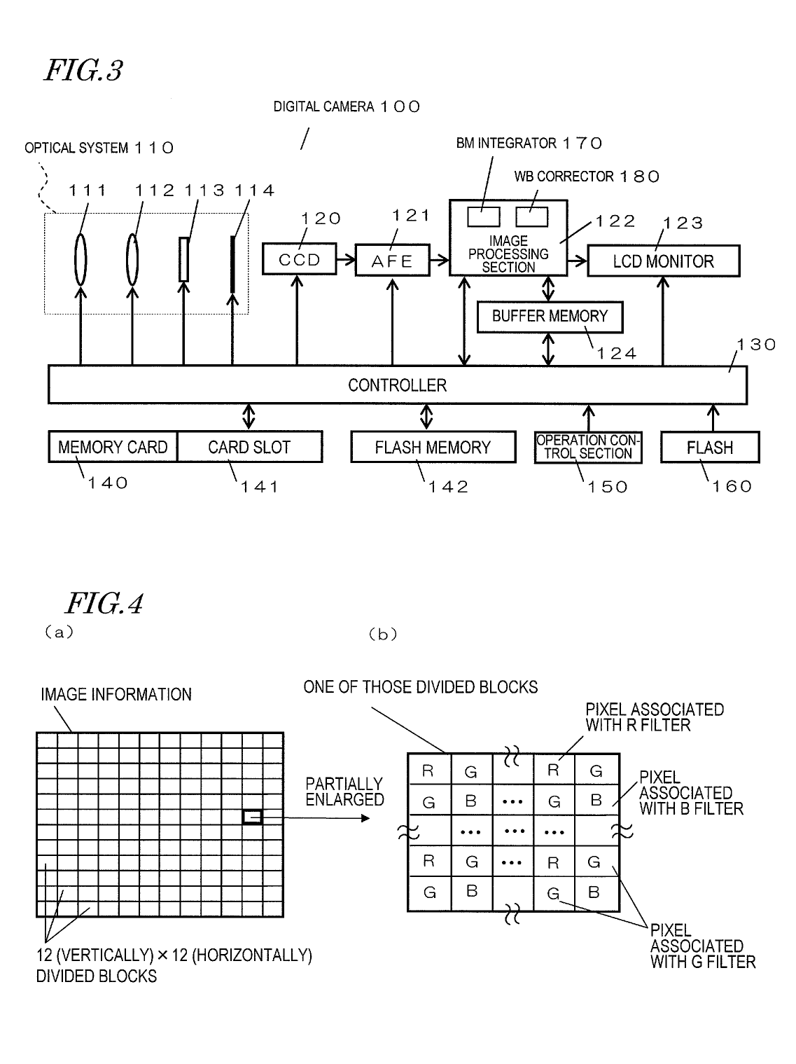

In a digital camera 100 according to a first specific preferred embodiment of the present invention, image information is generated by a CCD image sensor 120 (see FIG. 3), has its white balance adjusted in accordance with a white balance control value, and then a color corresponding to the white balance control value of the image information is changed. As a result, the colors of an image can be fine-tuned into appropriate ones. Hereinafter, the configuration and operation of the digital camera 100 will be described.

### 1. Configuration

Hereinafter, the configuration of the digital camera 100 will be described with reference to the accompanying drawings.

### 1-1. Configuration of Digital Camera 100

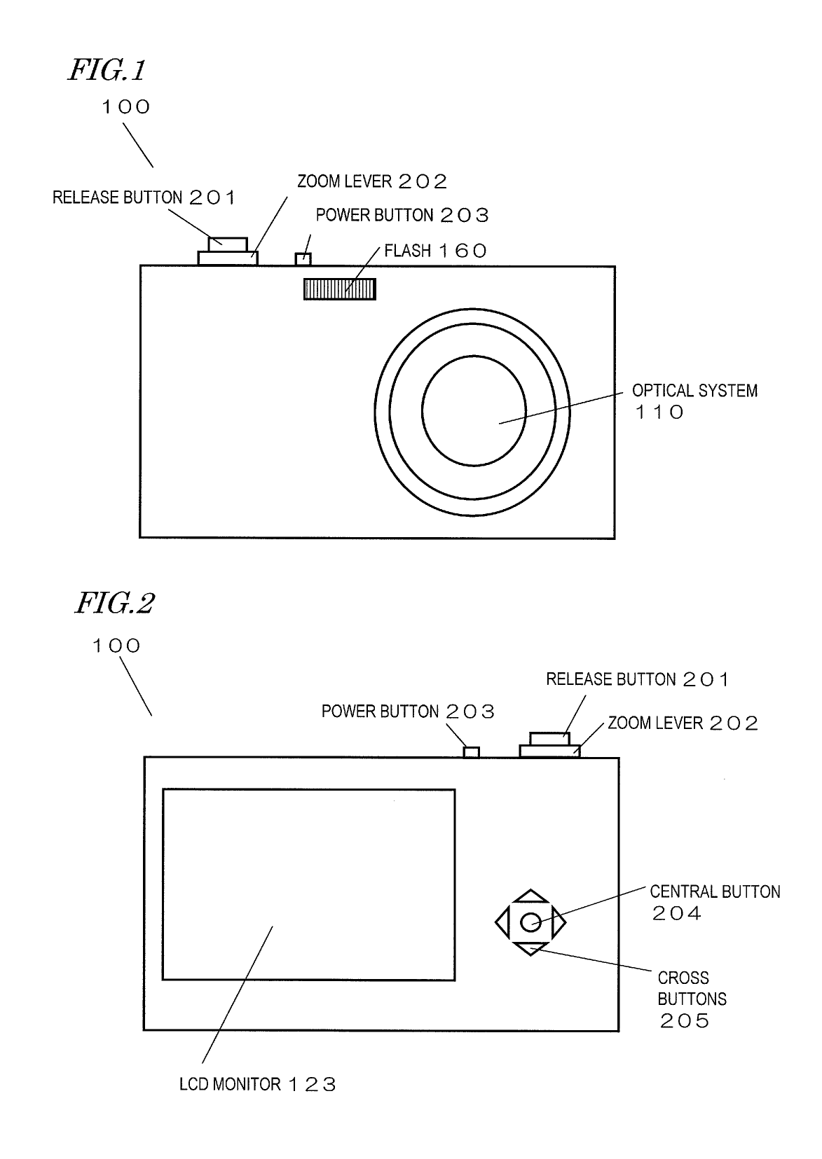

FIG. 1 is a front view of the digital camera 100, which includes a barrel that houses an optical system 110 and a flash 160 on its front side and which also includes a release button 201, a zoom lever 202, a power button 203, and other operating buttons at the top.

FIG. 2 is a rear view of the digital camera 100, which includes an LCD monitor 123, a central button 204, cross buttons 205 and other operating buttons on the rear side.

FIG. 3 illustrates an electrical configuration for the digital camera 100. In this digital camera 100, a subject image that has been produced by the optical system 110 is captured by the CCD image sensor 120, which generates image information representing the subject image that has been captured. The image information that has been generated by capturing is then subjected to various kinds of processing by an AFE (analog front end) 121 and an image processing section 122. The image information thus generated is also stored in a flash memory 142 or in a memory card 140, and then displayed on the LCD monitor 123 in accordance with the user's instruction that has been entered through an operation control section 150. Hereinafter, these components shown in FIGS. 1 to 3 will be described in detail one by one.

The optical system 110 includes a focus lens 111, a zoom lens 112, a diaphragm 113 and a shutter 114. Although not shown in FIG. 3, the optical system 110 may further include an OIS (optical image stabilizer) lens as well. It should be noted that this optical system 110 may includes any other number of lenses and may be made up of any number of groups of lenses. Optionally, the diaphragm 113 may be replaced with an ND filter in order to control the amount of light entering this camera.

The focus lens 111 is used to control the degree of focusing of the subject. The zoom lens 112 is used to adjust the angle of view of the subject. The diaphragm 113 is used to control the amount of the light entering the CCD image sensor 120. The shutter 114 is used to control the exposure time of the light entering the CCD image sensor 120. The focus lens 111, the zoom lens 112, the diaphragm 113 and the shutter 114 are driven by their associated drivers (such as a DC motor or a stepping motor) in accordance with a control signal supplied from the controller 130.

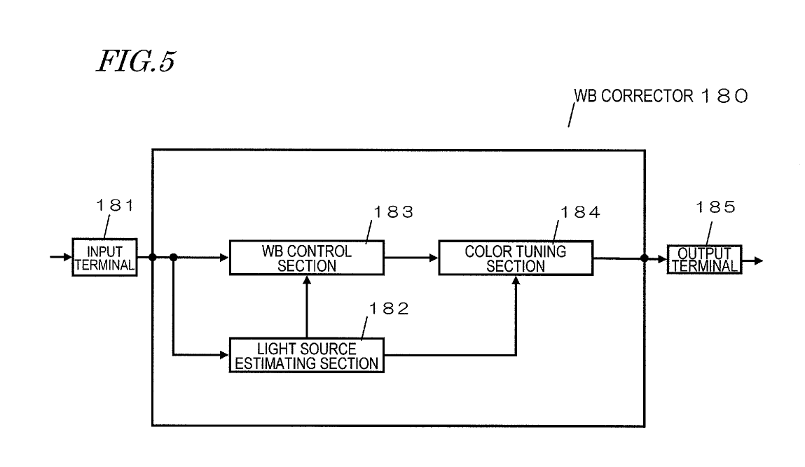

The CCD image sensor 120 captures the subject image that has been produced through the optical system 110, thereby generating image information. On the photosensitive plane of the CCD image sensor 120, arranged two-dimensionally are a huge number of photodiodes, for each of which color filters in the three primary colors of R, G and B are arranged in a predetermined pattern. In the example illustrated in portion (a) of FIG. 4, R, G and B color filters are arranged with respect to respective photodiodes at the ratio of one to two to one. The light that has come from the subject to shoot passes through the optical system 110 and then is imaged on the photosensitive plane of the CCD image sensor 120. Then, the subject image that has been produced there is converted into three groups of color information of R, G and B that have been sorted according to the intensities of the light incident on the respective photodiodes. As a result, overall image information representing the subject image is generated. Each of these photodiodes represents one pixel of the CCD image sensor 120. However, the color information to be actually output from each photodiode is R, G or B primary color information. That is why the color to be represented by each pixel will be generated later by the image processing section 122 based on the primary color information (including colors and intensities of light) provided by the photodiode associated with that pixel and its surround photodiodes. In the following description, a combination of R, G and B that form the color to be represented by each pixel will be referred to herein as (R, G, B). In this case, the R, G and B components of (R, G, B) indicate the respective percentages of those primary colors combined together. It should be noted that if the digital camera 100 is operating in shooting mode, the CCD image sensor 120 can generate a new frame of image information every predetermined period of time.

The AFE 121 subjects the image information, which has been read out from CCD image sensor 120, to noise reduction by correlated double sampling, amplification to the input range of an A/D converter (not shown) by an analog gain controller, and A/D conversion by the A/D converter. After that, the AFE 121 outputs the image information to the image processing section 122.

The image processing section 122 subjects the image information provided by the AFE 121 to various kinds of processing, which includes BM (block memory) integration, smear correction, white balance correction, gamma correction, YC conversion, digital zooming, compression and expansion. However, these are just examples of the present invention. The image processing section 122 may be implemented either as a hardwired electronic circuit or as a microcomputer that executes a program. Alternatively, the image processing section 122, the controller 130 and other components may form a single semiconductor chip as well.

A BM integrator 170 is included in the image processing section 122 in order to generate BM data with respect to the image information provided. FIG. 4 illustrates how this BM integrator 170 functions. As shown in portion (a) of FIG. 4, the BM integrator 170 divides the image information of the same frame that has been provided into a number of blocks (e.g., 144 (=12 vertically×12 horizontally) blocks). In this case, each of those blocks divided includes the same number of pieces of RGB primary color information as that of pixels per block as shown in portion (b) of FIG. 4.

Subsequently, the BM integrator 170 integrates together multiple values of each of the R, G and B channels, which are as many as the pixels per block, and then calculates the respective averages of the R light intensities, the G light intensities and B light intensities within each block. In this first specific preferred embodiment, the R, G and B color filters are arranged at the ratio of one to two to one for the respective photodiodes, and therefore, the number of G channels is twice as large as the number of R or B channels. With these channel numbers of R, G and B taken into account, the BM integrator 170 calculates the respective averages of the R, G and B light intensities within a block. Those averages of the R, G and B light intensities that have been thus calculated per block will be referred to herein as “BM data”. If the averages of the R, G and B light intensities within a block are identified by R_{AVG}, G_{AVG} and B_{AVG}, respectively, the BM data of that block can be represented as R_{AVG}, G_{AVG}, B_{AVG}). The BM data thus calculated is stored in a memory (not shown) on a block-by-block basis and will be retrieved as needed. In this manner, the BM integrator 170 generates the BM data for each of the 144 divided blocks.

The white balance corrector (which will be referred to herein as “WB corrector”) 180 is also included in the image processing section 122 in order to adjust the white balance (WB) and fine-tune a particular color with respect to the image information entered. FIG. 5 illustrates a configuration for the WB corrector 180, which includes an input terminal 181, a light source estimating section 182, a WB control section 183, a color tuning section 184 and an output terminal 185.

The input terminal 181 supplies the input BM data and image information to the light source estimating section 182 and the WB control section 183, respectively. The functions of the light source estimating section 182, the WB control section 183 and the color tuning section 184 will be described in detail later. The output terminal 185 outputs image information, of which the color has been fine-tuned appropriately by the light source estimating section 182, the WB control section 183 and the color tuning section 184. After having been output from the WB corrector 180, the image information is further subjected by the image processing section 122 to other kinds of image processing.

The LCD monitor 123 (see FIGS. 2 and 3) is arranged on the rear side of this digital camera 100 to display an image based on the image information that has been processed by the image processing section 122. The images displayed on the LCD monitor 123 include a through-the-lens image and a recorded image. As the through-the-lens image, a series of new frames of the image, which are generated by the CCD image sensor 120 at regular intervals, are presented continuously. Normally, when the digital camera 100 is operating in a shooting mode, the image processing section 122 generates the through-the-lens image based on the image information generated by the CCD image sensor 120. By viewing the through-the-lens image displayed on the LCD monitor 123, the user can shoot his or her subject while checking the composition. On the other hand, when the digital camera 100 is operating in a playback mode, the recorded image is presented on the LCD monitor 123 at a lower resolution by reducing the size of a high-resolution image stored in the memory card 140, for example. The image information of the high-resolution image to be stored in the memory card 140 is generated by the image processing section 122 based on the image information that has been generated by the CCD image sensor 120 after having accepted the user's instruction that has been entered by pressing the release button 201.

The controller 130 controls and regulates the overall operation of this digital camera 100, and includes a ROM to store program information and other sorts of information and a CPU to process the program information. The ROM stores not only programs about an autofocus (AF) control, an autoexposure (AE) control and a flash (160) emission control but also a program to regulate and control the overall operation of digital camera 100 as well.

The controller 130 may be implemented as either a hardwired electronic circuit or a microcomputer. Alternatively, the controller 130 and the image processing section 122 may form a single semiconductor chip. Also, the ROM does not have to be one of the internal components of the controller 130 but may also be outside of the controller 130 as well.

The buffer memory 124 is storage means that functions as a work memory for the image processing section 122 and the controller 130 and may be implemented as a DRAM (dynamic random access memory), for example. Meanwhile, the flash memory 142 functions as an internal memory to store the image information and other kinds of information.

The card slot 141 is connection means, to/from which the memory card 140 is readily insertable and removable, and can be connected to the memory card 140 both electrically and mechanically. Optionally, the card slot 141 may have the function of controlling the memory card 120.

The memory card 140 is an external memory with an internal storage device such as a flash memory, and can store data such as the image information to be processed by the image processing section 122.

The operation control section 150 is a generic term that refers collectively to a number of operating buttons and dials that are arranged on the outer shell of this digital camera 100, and accepts the user's instructions.

Specifically, the operation control section 150 includes the release button 201, the zoom lever 202, the power button 203, the central button 204 and the cross buttons 205 shown in FIGS. 1 and 2. On accepting the user's instruction, the operation control section 150 sends various operation instruction signals to the controller 130.

The release button 201 is a two-stage press button that can be pressed down halfway and all the way. Specifically, when the release button 201 is pressed halfway by the user, the controller 130 performs the autofocus (AF) control and the autoexposure (AE) controls, thereby determining the shooting condition. And when the release button 201 is pressed down all the way by the user, the controller 130 writes the image information, which has been captured when the button is pressed down fully, as the recorded image on the memory card 140.

The zoom lever 202 is a lever that is used to adjust the angle of view and that automatically returns to its neutral position between the wide-angle and telephoto ends. When turned by the user, the zoom lever 202 sends an operation instruction signal to drive the zoom lens 112 to the controller 130. Specifically, if the zoom lever 202 is turned to the wide-angle end, the controller 130 drives the zoom lens 112 so as to shoot the subject at a wide angle. On the other hand, if the zoom lever 201 is turned to the telephoto end, the controller 130 drives the zoom lens 112 so as to shoot the subject at a telephoto angle.

The power button 203 is a press button for turning ON and OFF the supply of electric power to respective components of the digital camera 100. If the power button 203 is pressed by the user in power OFF state, the controller 130 supplies electric power to the respective components of the digital camera 100 to activate them. On the other hand, if the power button 203 is pressed by the user in power ON state, the controller 130 stops supplying electric power to those components.

The central button 204 is another press button. If the central button 204 is pressed by the user when the digital camera 100 is operating in either the shooting mode or the playback mode, the controller 130 gets a menu displayed on the LCD monitor 123. The menu is displayed on the screen to allow the user to determine the settings of the shooting and playback conditions. When pressed while those condition settings are being chosen, the central button 204 also functions as an ENTER button.

The cross buttons 205 are yet another set of press buttons, which are arranged over, under, and on the right and left of the central button 204. By pressing any of these cross buttons 205, the user can choose the various condition settings that are being displayed on the LCD monitor 123.

The flash 160 includes a xenon tube, a capacitor, a booster, and an emission trigger circuit. In accordance with a control signal supplied from the controller 130, the booster applies a high voltage to the capacitor. Also in accordance with a control signal supplied from the controller 130, the emission trigger circuit discharges the high voltage that has been applied to, and stored in, the capacitor, thereby instantaneously emitting flash light from the xenon gas in the xenon tube synchronously with the shooting operation. As a result, the digital camera 100 can shoot the subject with the flash light. That is to say, by firing the flash 113 instantaneously with respect to the subject, the subject can be shot with the lack of brightness compensated for. Firing of the flash 160 includes preliminary flashing and main flashing. Before the subject is actually shot, preliminary flashing is needed in order to measure the distance to the subject based on the amount of the flash light reflected from the subject (which will be referred to herein as a “reflection level”) and determine the intensity of the flash light to be emitted by the flash 113 when the subject is actually shot. On the other hand, main flashing refers to the flash light to be emitted with the intensity that has been determined by preliminary flashing and synchronously with the shooting operation.

### 1-2. Correspondence Between Respective Components and What is Claimed

The CCD image sensor 120 is an example of an image capturing section according to the present invention. The light source estimating section 182 is an example of a control value calculating section according to the present invention. The WB control section 183 is an example of a white balance adjusting section according to the present invention. The color tuning section 184 is an exemplary color tuning section according to the present invention. The BM integrator 170 is an exemplary block memory data calculating section according to the present invention. The controller 130 is an example of the control section of the present invention. The color range of the entire image information is an example of the first color range of the present invention. The mercury-vapor lamp is an example of a particular light source according to the present invention. And the digital camera 100 is a preferred embodiment of an image capture device according to the present invention.

### 2. Color Control Operation

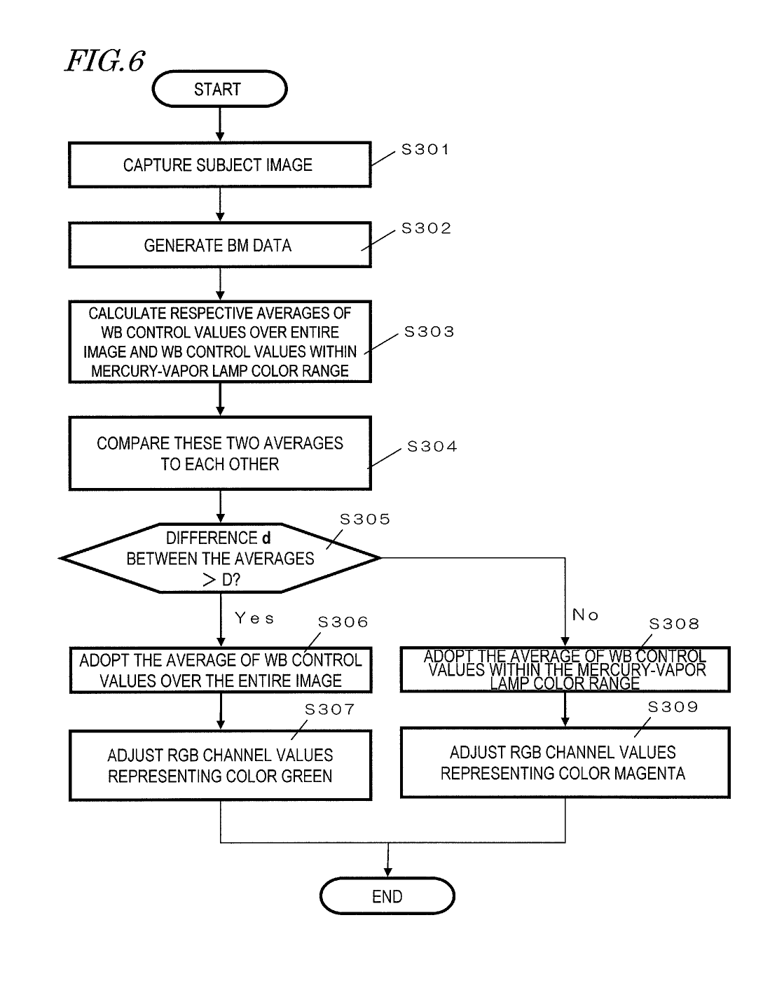

Hereinafter, the color tuning operation to be performed by this digital camera 100 will be described with reference to FIG. 6, which is a flowchart showing how the digital camera 100 fine-tunes the colors according to this first preferred embodiment.

If the digital camera 100 is operating in the shooting mode, the CCD image sensor 120 captures a subject image and generates image information in Step S301. The controller 130 instructs the AFE 121 to subject the image information that has been generated by the CCD image sensor 120 to various kinds of processing and then output it to the image processing section 122. Subsequently, the controller 130 makes the BM integrator 170 generate BM data for respective divided blocks as described above based on the image information that been entered into the image processing section 122 (in Step S302). Then, the controller 130 outputs the image information and BM data thus generated to the WB corrector 180.

The controller 130 outputs the BM data for the respective divided blocks to the light source estimating section 182 in the WB corrector 180. Based on the BM data provided, the light source estimating section 182 calculates WB control values (or gains) with respect to the respective BM data. In this case, the light source estimating section 182 calculates the WB control values by dividing G by either R or B according to the weights that have been set for respective color ranges.

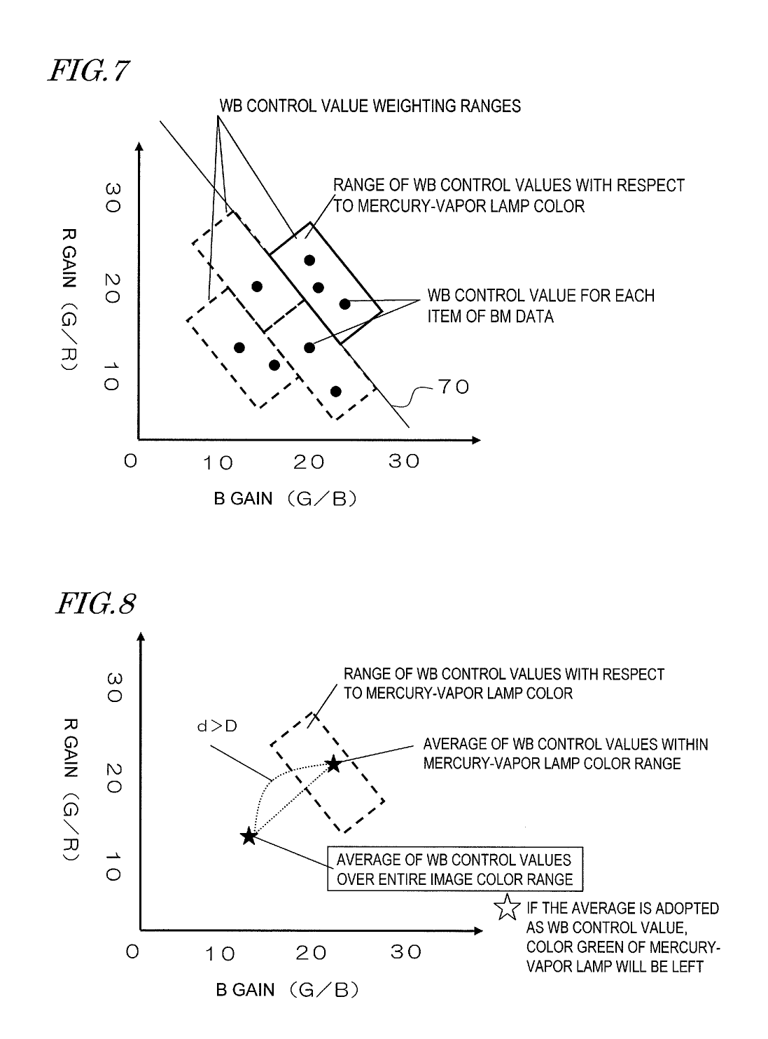

FIG. 7 is a schematic representation showing how WB control values that have been generated for the respective divided BMs may be plotted in an R-B space. If an image signal is divided into 12 (vertically)×12 (horizontally) blocks, then the total number of BMs is 144. In FIG. 7, only a few of them are plotted for convenience sake, and R and G gains are normalized with respect to G. That is to say, in FIG. 7, the ordinate represents a WB control value obtained as a G/R ratio, while the abscissa represents a WB control value obtained as a G/B ratio. The ROM (not shown) in the controller 130 has information about the range of WB control values (or gains) with respect to the color of a mercury-vapor lamp (which will be referred to herein as a “mercury-vapor lamp color range”). For example, the range that is defined on the upper-right side of the line 70 shown in FIG. 7 represents the mercury-vapor lamp color. Also, the range defined by the solid-line rectangle in FIG. 7 indicates the mercury-vapor lamp color range in a situation where weights are added. By reference to the mercury-vapor lamp color range information, the controller 130 can see how many BMs have WB control values falling within this range. Then, the controller 130 sends information about the number of BMs that falls within the mercury-vapor lamp color range with the WB control values generated to the light source estimating section 182. As a result, the light source estimating section 182 can calculate the average of the WB control values falling within the mercury-vapor lamp color range and that of the WB control values over the entire color range (in Step S303).

Subsequently, the light source estimating section 182 compares the average of the WB control values falling within the mercury-vapor lamp color range to that of the WB control value over the entire color range, thereby calculating the difference d between these two averages (in Step S304). Thereafter, the light source estimating section 182 compares the (magnitude of) difference d thus calculated between the two averages to a predetermined threshold value D (in Step S305).

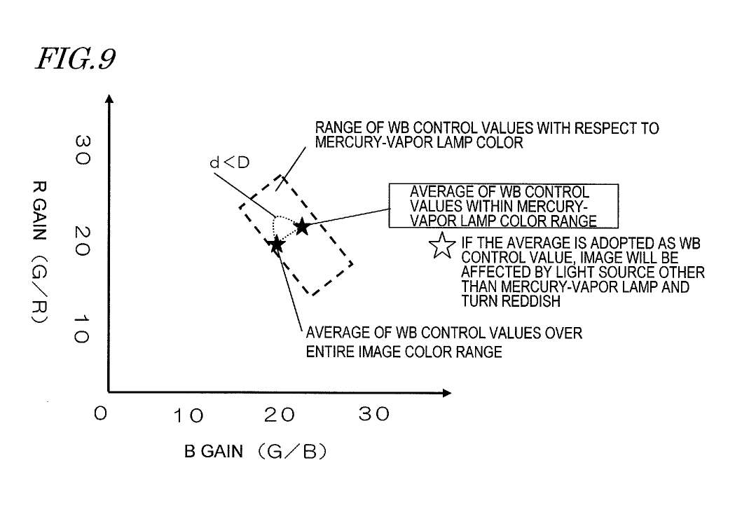

FIG. 8 shows a situation where the difference d between the average of the WB control values falling within the mercury-vapor lamp color range and that of the WB control values over the entire image is greater than the predetermined threshold value D. On the other hand, FIG. 9 shows a situation where the difference d is smaller than the predetermined threshold value D. Depending on which of these two situations shown in FIGS. 8 and 9 is true, the WB control value that will be used later to make WB adjustment changes for the following reason. Specifically, if the difference d between those two averages is greater than the predetermined threshold value D as shown in FIG. 8, it means that the color of the image information captured is hardly affected by the presence of a mercury-vapor lamp. In that case, the light source estimating section 182 adopts the average of the WB control values that has been calculated over the entire color range of the image as a WB control value for use to make WB adjustment (in Step S306). The WB control value thus adopted will be represented herein by (α, 1, β) in the order of R, G and B.

On the other hand, if the difference d between those two averages is smaller than the threshold value D as shown in FIG. 9, it means that the color of the image information captured is significantly affected by the presence of a mercury-vapor lamp. In that case, the light source estimating section 182 adopts the average of the WB control values that has been calculated within the mercury-vapor lamp color range as a WB control value for use to make WB adjustment (in Step S308). The WB control value thus adopted will be represented herein by (α′, 1, β′) in the order of R, G and B. In any case, the light source estimating section 182 notifies the WB control section 183 and the color tuning section 184 of the WB control value adopted. If the difference d between the two averages is equal to the threshold value D, then the average of the WB control values that has been calculated over the entire image color range is adopted as a WB control value for use to make WB adjustment. According to the settings of the device, however, the average of the WB control values that has been calculated within the mercury-vapor lamp color range may also be adopted as a WB control value for use to make WB adjustment.

Th WB control section 183 gets the image information through the input terminal 181 and also gets the WB control value adopted from the light source estimating section 182. Then, the WB control section 183 makes WB adjustment on the image information using the WB control value adopted. Specifically, for that purpose, the WB control section 183 multiplies the RGB combination (R, G, B) of one pixel of the image information by the WB control value that has been adopted in Step S305 or S306. If the average of the WB control values that has been calculated over the entire image color range is adopted as a WB control value for use to make this WB adjustment, then the color information to be obtained by making the WB adjustment will be (αR, G, βB). On the other hand, if the average of the WB control values that has been calculated within the mercury-vapor lamp color range is adopted as a WB control value for use to make this WB adjustment, then the color information to be obtained by making the WB adjustment will be (α′R, G, β′B). Then, the WB control section 183 supplies the image information that has been subjected to the WB adjustment to the color tuning section 184.

The color tuning section 184 gets the image information that has been subjected to the WB adjustment from the WB control section 183, and also gets the WB control value adopted from the light source estimating section 182. Depending on whether the WB control value adopted has been calculated over the entire image color range or within the mercury-vapor lamp color range, the color tuning section 184 fine-tunes the color of the image information that has been subjected to the WB adjustment.

Specifically, if the image information has been subjected to the WB adjustment by using the WB control value that has been calculated over the entire image color range, then the finished image will have a tint of the color green of the mercury-vapor lamp. In that case, the color tuning section 184 sets the RGB combination value representing the color green to be relatively low by reference to the color information (αR, G, βB) of the image information (in Step S307). The RGB combination value may be decreased by approximately 10-20%, for example. The adjustment is preferably made on a pixel-by-pixel basis. The range of the RGB values that the color tuning section 184 finds representing the color green is stored in advance on a ROM (not shown). Thus, the color tuning section 184 can obtain an image in appropriate colors by fine-tuning the tint of the color green of the mercury-vapor lamp that is left in the image.

On the other hand, if the image information has been subjected to the WB adjustment by using the WB control value that has been calculated within the mercury-vapor lamp color range, then the finished image will have a tint of the color red of a light source other than the mercury-vapor lamp. In that case, the color tuning section 184 sets the RGB combination value representing the color magenta to be relatively low by reference to the color information (α′R, G, β′B) of the image information (in Step S309). The RGB combination value may be decreased by approximately 10-20%, for example. The adjustment is also preferably made on a pixel-by-pixel basis. The range of the RGB values that the color tuning section 184 finds representing the color magenta is stored in advance on a ROM (not shown). Thus, the color tuning section 184 can obtain an image in appropriate colors by fine-tuning the tint of the color red that is left in the image.

### 3. Summary

As described above, the digital camera 100 of this first preferred embodiment includes: a CCD image sensor 120 for capturing a subject image and generating image information; a light source estimating section 182 for calculating a white balance control value in order to adjust the white balance of the image information; a WB control section 183 for adjusting the white balance of the image information in accordance with the white balance control value; and a color tuning section 184 for changing a color corresponding to the white balance control value of the image information of which the white balance has been adjusted. Thus, after the white balance of the image information that has been generated by the CCD image sensor 120 has been adjusted in accordance with the white balance control value, the digital camera 100 changes a color corresponding to the white balance control value of the image information. Consequently, the present invention provides a digital camera 100 that can fine-tune the colors so that an image captured has appropriate colors.

The digital camera 100 of the first preferred embodiment further includes a controller 130 for instructing the light source estimating section 182 to calculate first and second white balance control values based on two pieces of information about the colors of the image information that fall within first and second color ranges, respectively. The light source estimating section 182 compares the first and second white balance control values to each other, thereby determining, based on a result of the comparison, the white balance control value to adjust the white balance. Thus, the digital camera 100 compares to each other the first and second white balance control values that have been calculated based on two pieces of information about the colors of the image information that fall within first and second color ranges, respectively, and then determines, based on a result of the comparison, the white balance control value to adjust the white balance. Consequently, the present invention provides a digital camera 100 that can calculate an appropriate white balance control value based on two pieces of information about the colors of the image information that fall within the first and second color ranges, respectively.

Also, in the digital camera 100 of this first preferred embodiment, the first color range includes colors of the entire image information, and the second color range indicates a particular light source color. If the white balance of the image information has been adjusted based on the first white balance control value falling within with the entire image information color range, the color tuning section 184 fine-tunes a first color corresponding to the particular light source color. On the other hand, if the white balance of the image information has been adjusted based on the second white balance control value falling within the color range of the particular light source color, the color tuning section 184 fine-tunes a second color corresponding to the particular light source color. Thus, the digital camera 100 fine-tunes each color corresponding to a particular light source color depending on in which color range the white balance control value has been calculated. Consequently, the present invention provides a digital camera 100 that can fine-tune the color that could be affected by the presence of a particular light source depending on in which color range the white balance control value has been calculated.

In the digital camera 100 of the first preferred embodiment described above, the particular light source is a mercury-vapor lamp, and the first and second colors are green and magenta, respectively. Thus, the present invention provides a digital camera 100 that can still fine-tune the colors of an image appropriately even if the image has been captured under a mercury-vapor lamp.

### Alternative Embodiments

The present invention is in no way limited to the specific preferred embodiment described above but may be readily modified in various manners. Those alternative preferred embodiments of the present invention will be described collectively.

In the preferred embodiment described above, the image capturing section is supposed to be the CCD image sensor 120. However, this is only an example of the present invention. Alternatively, a CMOS image sensor, an NMOS image sensor or any other image sensor may also be used according to the present invention. Also, in the preferred embodiment described above, the arrangement of filters for separating colors is supposed to consist of RGB primary color filters. However, the arrangement of filters may also be made up of CMY complementary color filters. Furthermore, the image capture device of the present invention may have three panels with three image sensors provided for the three primary colors of R, G and B, respectively, or even more panels.

Also, in the preferred embodiment described above, the WB corrector 180 is supposed to consist of the light source estimating section 182, the WB control section 183 and the color tuning section 184. However, this is just an example of the present invention. Alternatively, the functions of the light source estimating section 182, the WB control section 183 and the color tuning section 184 may also be performed by making the controller 130 and the image processing section 122 execute a predetermined program.

Furthermore, in the preferred embodiment described above, the WB corrector 180 is supposed to get the WB adjusted by the WB control section 183 and then provide the image information for the color tuning section 184. However, the same effect will also be achieved by the present invention even if it is not until not only the WB adjustment by the WB control section 183 but also another process have been performed that the image information is provided for the color tuning section 184.

Furthermore, in the preferred embodiment described above, the light source estimating section 182 is supposed to calculate the average of WB control values over the entire image color range. However, the present invention is in no way limited to that specific preferred embodiment. Alternatively, the average of the WB control values may also be calculated in only a portion of that image color range after an unnecessary color range, which would cause a color collapse, has been removed from the entire image color range. Also, although the WB control section 183 is supposed to use the average of the WB control values falling within the mercury-vapor lamp color range in the preferred embodiment described above if the difference d between the averages is smaller than a predetermined threshold value D, this is just an example of the present invention, too. That is to say, if the difference d between the averages is smaller than the predetermined threshold value D, then there will not be a significant difference between the average of the WB control values falling within the mercury-vapor lamp color range and that of the WB control values over the entire image color range. For that reason, the average of the WB control values that has been calculated over the entire image color range may also be used instead. Even so, by performing the processing step S309 shown in FIG. 6, the reddish portion of the image can be fine-tuned and an image in appropriate colors can also be obtained. Furthermore, in the preferred embodiment described above, each WB control value is supposed to be represented as (α, 1, β) in the order of R, G and B. However, the WB control value may also be (α, γ, β) without normalizing the R or B value with respect to the G value.

Optionally, the preferred embodiment of the present invention described above may also be modified so that the color tuning section 184 changes the degree of color tuning linearly according to the difference d between the average of the WB control values falling within the mercury-vapor lamp color range and that of the WB control values over the entire image color range. Specifically, if the difference d between the averages is much greater than the predetermined threshold value D, the colors may be fine-tuned so as to make the color green more intense. On the other hand, if the difference d is just moderately greater than the predetermined threshold value D, then the colors may be fine-tuned so as to make the color green less intense. Likewise, if the difference d between the averages is smaller than the predetermined threshold value D and is close to zero, the colors may be fine-tuned so as to make the color magenta more intense. But if the difference d is just a bit smaller than the predetermined threshold value D, then the colors may be fine-tuned so as to make the color magenta less intense. In this manner, even if the image has been captured under a particular light source such as a mercury-vapor lamp, the digital camera 100 can still fine-tune the colors, depending on how much that light source color affects the image, so that the image has appropriate colors.

Furthermore, in the preferred embodiment described above, the digital camera 100 is supposed to store, on a ROM in advance, the ranges of the RGB values to be sensed by the color tuning section 184 to be green or magenta. However, the present invention is in no way limited to that specific preferred embodiment. That is to say, the color green or magenta may also be sensed by L*a*b* of the YCrCb color space or the CIELAB color space instead of the RGB color space.

Also, in the preferred embodiment described above, the digital camera 100 is supposed to control the color green or magenta by making a decision with respect to a single predetermined threshold value D. However, this is only an example of the present invention. Optionally, another predetermined threshold value D′, which is greater than the predetermined threshold value D, may also be used in addition to the predetermined threshold value D. In that case, if the difference d between the average of the WB control values falling within the mercury-vapor lamp color range and that of the WB control values over the entire image color range is smaller than the predetermined threshold value D, the influence of the mercury-vapor lamp may be determined to be significant, and the color green may be fine-tuned after the WB adjustment has been made. On the other hand, if the difference d is greater than the additional predetermined threshold value D′ that is larger than the predetermined threshold value D, then the influence of the mercury-vapor lamp may be determined to be limited, and the color magenta may be controlled after the WB adjustment has been made. Furthermore, if the difference d is between those two predetermined threshold values D and D′, either the color green or the color magenta may have its intensity decreased, or even no color tuning may be performed at all, depending on which of those two threshold values D and D′ the difference d is closer to.

In the preferred embodiment described above, BMs to be plotted in the mercury-vapor lamp color range are supposed to be present. However, if there are no BMs to be plotted in the mercury-vapor lamp color range and if no WB control values can be calculated with respect to the mercury-vapor lamp color range, the color tuning computations may be made later by substituting the predetermined threshold value D for the difference d between the average of the WB control values falling within the mercury-vapor lamp color range and that of the WB control values over the entire image color range.

Furthermore, in the preferred embodiment described above, the particular light source is supposed to be a mercury-vapor lamp. However, this is just an example of the present invention. That is to say, the present invention is also applicable to even a situation where the image is affected by any other particular light source such as a daylight color fluorescent lamp, an incandescent lamp or an LED lamp. Among other things, the present invention is particularly effectively applicable to an image to be affected by light with a single spectrum. Not just a mercury-vapor lamp but also a sodium-vapor lamp is also such a light source with a single spectrum.

If color tuning is going to be performed on an image with the light that has been cast by a sodium-vapor lamp, then the mercury-vapor lamp color range that has been described with reference to FIG. 6 is replaced with a sodium-vapor lamp color range. The range of the WB control values with respect to the sodium-vapor lamp color is smaller by about 15 along the axis of ordinates (in the R gain direction) and greater by about 5 along the axis of abscissas (in the B gain direction) than that of the WB control values with respect to the mercury-vapor lamp color as shown in FIG. 7. Also, in processing step S307, the RGB combination value representing the color orange is set to be relatively low in the color information (αR, G, βB) of the image information. Then, in processing step S309, the RGB combination value representing the color blue is set to be relatively low in the color information (α′R, G, β′B) of the image information. As a result, an image in appropriate colors can be obtained.

The color green and the color magenta are complementary to each other, so are the color orange and the color blue. Thus, by performing the processing step S309 of decreasing the intensity of a color (such as the color magenta or the color blue) that is complementary to a particular color (such as the color green or the color orange) that is expressed with a relatively high intensity in the processing step S306, even an image to be significantly affected by the particular light source can also have its color fine-tuned appropriately.

Furthermore, in the preferred embodiment described above, the BM integrator 170 is supposed to calculate the respective averages of the R light intensities, the G light intensities and the B light intensities. In this case, the “average” may be either a value obtained by integrating together the R light intensities, G light intensities or B light intensities or a value obtained by dividing the sum of the R light intensities, G light intensities or B light intensities by their number of samples.

Furthermore, in the preferred embodiment described above, the memory card 140 is used as an external memory. However, the external memory may also be any of various semiconductor memories, an HDD or an optical disc as well.

As described above, the present invention provides an image capture device that can fine-tune colors so that the image captured has appropriate colors.

It should be noted that the present invention does not have to be implemented as a digital camera. Rather the present invention is applicable to a movie camera, a cellphone with camera, or any other image capture device that makes white balance adjustment during shooting.

What is claimed is:

1. An image capture device comprising:
an image capturing section for capturing a subject image and generating image information;
a control value calculating section for calculating a white balance control value in order to adjust the white balance of the image information;
a white balance adjusting section for adjusting the white balance of the image information in accordance with the white balance control value; and
a color tuning section for changing a color corresponding to the white balance control value of the image information of which the white balance has been adjusted.

2. The image capture device of claim 1, wherein the control value calculating section calculates first and second white balance control values based on two pieces of information about the colors of the image information that fall within first and second color ranges, respectively, and
wherein the control value calculating section compares the first and second white balance control values to each other, thereby determining, based on a result of the comparison, the white balance control value to adjust the white balance of the image information.

3. The image capture device of claim 2, wherein the first color range includes colors of the entire image information, and
wherein the second color range indicates a particular light source color, and
wherein if the white balance of the image information has been adjusted based on the first white balance control value, the color tuning section fine-tunes a first color corresponding to the particular light source color, and
wherein if the white balance of the image information has been adjusted based on the second white balance control value, the color tuning section fine-tunes a second color corresponding to the particular light source color.

4. The image capture device of claim 3, wherein the particular light source is a mercury-vapor lamp, and
wherein the first and second colors are green and magenta, respectively.

5. The image capture device of claim 3, wherein the particular light source is a sodium-vapor lamp, and
wherein the first and second colors are orange and blue, respectively.

6. The image capture device of claim 3, wherein the first and second colors are complementary to each other.

7. The image capture device of claim 2, further comprising a block memory data calculating section for dividing the image information into a number of blocks and calculating block memory data, representing average light intensities of primary colors, on a block-by-block basis, and
wherein the control value calculating section calculates the first and second white balance control values based on block memory data that are associated with the first and second color ranges, respectively.

8. The image capture device of claim 2, wherein the control value calculating section calculates the difference between the first and second white balance control values, compares the difference to a predetermined threshold value, and uses, based on a result of the comparison, one of the first and second white balance control values as the white balance control value to adjust the white balance of the image information.

9. An image processing method comprising the steps of:
calculating a white balance control value in order to adjust the white balance of image information that has been entered;
adjusting the white balance of the image information in accordance with the white balance control value; and
changing a color corresponding to the white balance control value of the image information of which the white balance has been adjusted.
